(19) United States
(12) Patent Application Publication
(10) Pub. No.: US 2014/0050814 A1
(43) Pub. Date: Feb. 20, 2014

(54) EMBOSSING ASSEMBLY AND METHODS OF PREPARATION

(71) Applicants: Gary Yih-Ming KANG, Fremont, CA (US); Hanan Liu, Milpitas, CA (US); Du Quy Le, San Jose, CA (US)

(72) Inventors: Gary Yih-Ming KANG, Fremont, CA (US); Hanan Liu, Milpitas, CA (US); Du Quy Le, San Jose, CA (US)

(21) Appl. No.: 13/588,973

(22) Filed: Aug. 17, 2012

(51) Int. Cl. B29C 59/04; B32B 37/02

(52) U.S. Cl. 425/470; 156/154; 156/185; 156/92

(57) ABSTRACT

The invention is directed to an embossing assembly and methods for its preparation. The assembly comprises a drum, a non-expandable insert and an embossing sleeve and it is particularly useful for the preparation of microcups used in a display device. The assembly may also comprise only a drum and an embossing sleeve.

### FIELD OF THE INVENTION

The present invention is directed to an embossing assembly and methods for its preparation.

### BACKGROUND OF THE INVENTION

U.S. Pat. No. 7,767,126 discloses an embossing assembly and methods for its manufacture. In one embodiment of the US patent, an expandable insert is described to be part of an embossing assembly. The insert is placed between an embossing sleeve and a drum, and the insert and the sleeve may be sequentially mounted onto the drum. The insert may be a layer of a circular shape which may have one or multiple open gaps in the longitudinal direction. At both ends of the insert, there may be tightening means, such as screws, to secure the insert over the drum. By tightening or loosening the screws, the diameter of the insert may be adjusted to ensure tight fitting of the embossing sleeve over the insert and simultaneously the concentricity of the embossing sleeve over the drum.

U.S. Pat. No. 7,767,126 also describes how the three-dimensional micro-posts are formed on the surface of an embossing sleeve. The assembly is then used as an embossing tool for forming microcups which are described in U.S. Pat. No. 6,930,818. The microcups, when filled with an electrophoretic fluid comprising charged pigment particles dispersed in a solvent, are a crucial part of an electrophoretic display device.

The embossing assembly of U.S. Pat. No. 7,767,126 works well, in most cases, for forming the microcups. However, it is not particularly suitable for an embossing composition which is viscous. When a viscous embossing composition is used, the microcups formed using the assembly may not have a uniform bottom thickness. In addition, this deficiency could also occur when the embossing assembly is relatively large in size.

### SUMMARY OF THE INVENTION

One aspect of the present invention is directed to an embossing assembly, which comprises:
a) a drum;
b) a non-expandable insert mounted over the drum wherein the insert comprises a groove on its longitudinal direction; and
c) an embossing sleeve formed from an embossing shim wherein the embossing shim with a three-dimensional pattern on its outer surface is mounted over the insert and the two ends of the embossing shim are folded into the groove on the insert and secured in the groove by a filler material.

In one embodiment, the three-dimensional pattern has micro-posts.

In one embodiment, the cross-section of the groove has two sides with an angle, from its vertical axis, of about 0° to about 85°. In one embodiment, the cross-section of the groove has a bottom width of 100 μm to 50 mm. In one embodiment, the cross-section of the groove has an opening width of 101 μm to 51 mm.

In one embodiment, the non-expandable insert has multiple tightening means. In one embodiment, the tightening means is screws.

Another aspect of the present invention is directed to a method for the manufacture of an embossing assembly, which method comprises:
a) providing a drum;
b) providing a non-expandable insert which has a groove on its outer surface in the longitudinal direction and tightening means;
c) providing an embossing shim with a three-dimensional pattern on one side of the shim;
d) wrapping the embossing shim over the non-expandable insert to form an embossing sleeve, with the three-dimensional pattern on the outer surface;
e) folding two ends of the embossing shim into the groove;
f) adding a filler material into the groove to secure the two ends of the embossing shim in the groove; and
g) optionally grinding and polishing the filler material.

In one embodiment, the non-expandable insert is mounted on the drum before the embossing shim is wrapped over the non-expandable insert.

In one embodiment, the non-expandable insert is mounted on the drum after the embossing shim is wrapped over the non-expandable insert.

A further aspect of the present invention is directed to an embossing assembly, which comprises:
a) a drum wherein the drum comprises a groove on its longitudinal direction; and
b) an embossing sleeve formed from an embossing shim wherein the embossing shim with a three-dimensional pattern on its outer surface is mounted over the drum and the two ends of the embossing shim are folded into the groove on the drum and secured in the groove by a filler material.

### BRIEF DESCRIPTION OF THE DRAWINGS

FIG. 1 depicts an embossing assembly of the present invention comprising three components, a drum, a non-expandable insert and an embossing sleeve.

FIGS. 2a and 2b illustrate a non-expandable insert and a groove on the insert.

FIG. 3 depicts an embossing shim with micro-posts on one side of the shim.

FIGS. 4a and 4b show how an embossing shim is mounted over a non-expandable insert with a groove.

FIG. 5 shows an embossing sleeve mounted over a non-expandable insert.

### DETAILED DESCRIPTION OF THE INVENTION

The present inventors have developed an embossing assembly which may be used for forming microcups, regardless of the viscosity of the embossing composition and the size of the embossing assembly.

In the first embodiment, the assembly comprises three components, a non-expandable insert, an embossing sleeve and a drum.

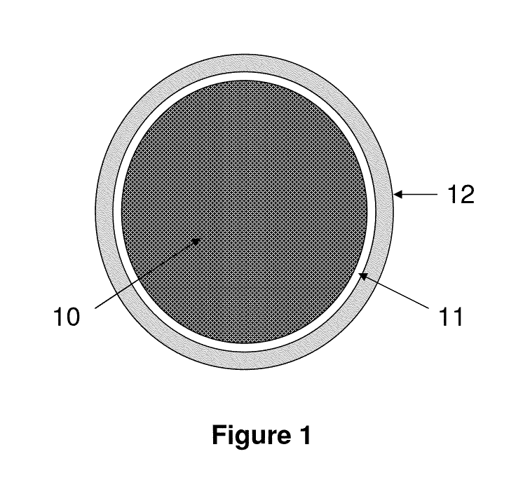

The three components are assembled as shown in FIG. 1 which is a cross-section view of the assembly. An embossing sleeve (12) and a non-expandable insert (11) are mounted over a drum (10), in sequence.

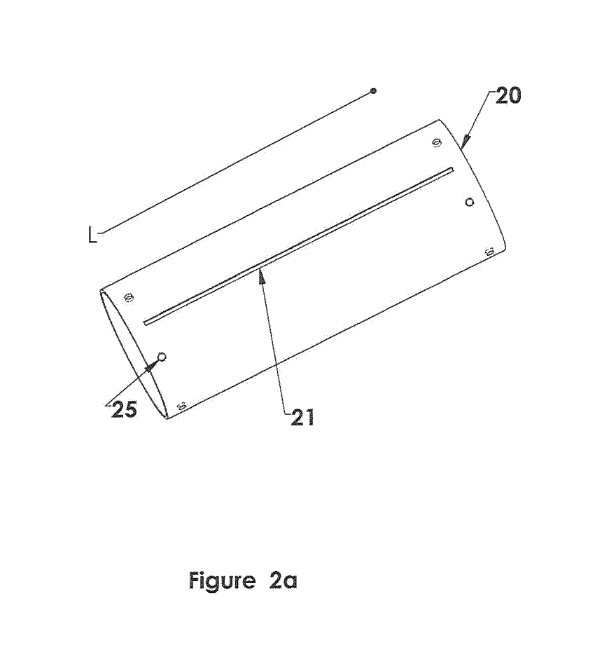

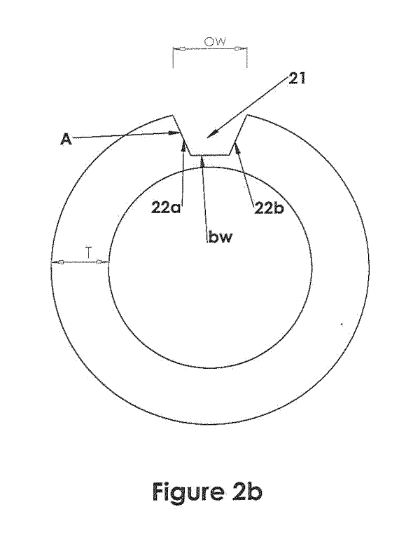

The non-expandable insert (20), as shown in FIG. 2a, is in the shape of a tube which can be snugly secured over a drum by tightening means, such as screws. In the longitudinal (L) direction of the insert, on its outer surface, there is a groove (21). The groove is not an open gap. FIG. 2b is a cross-section view of the insert. The size of the groove (21) is exaggerated for clarity. The two sides (22a and 22b) of the cross-section of the groove are preferably slanted. The angle A which is the angle between the side of 22a or 22b and a vertical axis, preferably is between about 0° to about 85°. In one embodiment, the bottom width (bw) of the groove is about 100 μm to about 50 mm. In one embodiment, the opening width (ow) of the groove is about 101 μm to about 51 mm.

The thickness (T) of the non-expandable insert is usually in a range from about 1 mm to about 100 mm and preferably from about 3 mm to about 50 mm.

The insert is formed of a material, such as a metal (e.g., aluminum, copper, zinc, nickel, iron, titanium, cobalt or the like), an alloy or metal oxide derived from any of the aforementioned metals or stainless steel. If the insert material is relatively susceptible to humidity or chemical conditions, e.g., copper or iron, a relatively inert layer or surface passivation may be employed to protect it. The deposition of the inert material may be carried out by electroplating, electroless plating, physical vapor deposition, chemical vapor deposition or sputtering deposition, over the entire surface of the insert. Alternatively, the insert may be formed of a plastic material, e.g., PVC (polyvinyl chloride), ABS (acrylonitrile butadiene styrene) or the like.

At both ends of the insert, there are tightening means (25 in FIG. 2a), such as screws, to secure the insert over the drum. After the insert is mounted over the drum and by adjusting the tightness of the screws, the insert is securely held around the drum and, furthermore, the concentricity of the embossing sleeve over the drum is ensured. The concentricity of the embossing sleeve over the drum is critically important to the quality of the embossed microstructures prepared from the embossing assembly. For best results, there are at least 3 screws spreading around the circle, preferably having an equal distance between each other.

In the context of the present invention, the term “embossing shim” refers to an embossing sheet with a three dimensional pattern formed on one side of the sheet. The embossing shim, when secured over the non-expandable insert, is referred to as an embossing sleeve.

The embossing shim, in the present invention, is preferably formed from an embossing sheet of a conductive material, such as a metal (e.g., aluminum, copper, zinc, nickel, chromium, iron, titanium, cobalt or the like), an alloy derived from any of the aforementioned metals or stainless steel. Alternatively, the embossing shim may be formed of an embossing sheet of a non-conductive material with a conductive coating or a conductive seed layer on its outer surface. Further alternatively, the embossing shim may be formed of an embossing sheet of a non-conductive material without a conductive material on its outer surface.

A three-dimensional pattern (e.g., micro-posts) is formed on one side of the embossing sheet, by any of the methods as described in U.S. Pat. No. 7,767,126, the content of which is incorporated herein by reference in its entirety.

Briefly, the three-dimensional pattern on the embossing sheet may be formed in multiple steps, such as

(1) A photosensitive material is coated over one side of the embossing sheet. Precision grinding and polishing may be used to ensure smoothness of the surface of the embossing sheet before coating. The photosensitive material may be of a positive tone, negative tone or dual tone. The photosensitive material may also be a chemically amplified photoresist. The coating may be carried out using dip, spray, drain or ring coating. The thickness of the photosensitive material is preferably greater than the depth or height of the three-dimensional pattern to be formed. After drying and/or baking, the photosensitive material is subjected to exposure. Alternatively, the photosensitive material can be a dry film photoresist (which is usually commercially available) that is laminated onto the surface of the embossing sheet.

(2) A suitable light source, e.g., IR, UV, e-beam or laser, is used to expose the photosensitive material coated. A photomask is optionally used to define the three-dimensional pattern to be formed on the photosensitive material. Depending on the pattern, the exposure can be one shot, step-by-step, continuous or a combination thereof.

After exposure, the photosensitive material may be subjected to post-exposure treatment, e.g., baking, before development. Depending on the tone of the photosensitive material, either exposed or un-exposed areas will be removed by using a developer. After development, the embossing sheet with a patterned photosensitive material on its surface may be subjected to baking or blanket exposure before deposition (e.g., electroplating, electroless plating, physical vapor deposition, chemical vapor deposition or sputtering deposition).

(3) A variety of metals or alloys (e.g., nickel, cobalt, chrome, copper, zinc, iron, tin, silver, gold or an alloy derived from any of the aforementioned metals) can be electroplated and/or electroless plated onto the embossing sheet. The plating material is deposited in areas that are not covered by the patterned photosensitive material. The deposit thickness is preferably less than that of the photosensitive material. The thickness variation of the deposit can be controlled to be less than 1%, by adjusting plating conditions, e.g., the distance between the anode and the cathode (i.e., flat sheet), if electroplating is used.

It is understood that the plating can be carried out on an embossing sheet that is made of a conductive material or a non-conductive material with a conductive coating or a conductive seed layer on its surface. For a non-conductive embossing sheet, the three dimensional pattern may be prepared by a method combining photolithography and etching, the details of which are given in the US patent identified above.

(4) After plating, an embossing shim can be obtained by stripping the patterned photosensitive material on the embossing sheet with a stripper (e.g., an organic solvent or aqueous solution). A precision polishing may be optionally employed to ensure acceptable thickness variation and degree of roughness of the deposit over the entire embossing shim.

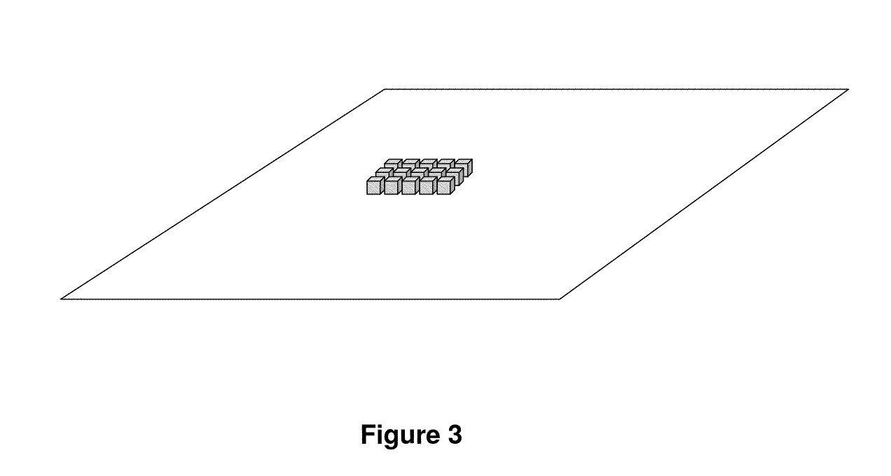

FIG. 3 is a three-dimensional view of an embossing shim, i.e., an embossing sheet with a three-dimensional pattern (e.g., micro-posts) formed thereon. It is noted that, as a representative, only a few number of the microposts are shown in FIG. 3 and their size is exaggerated for clarity.

If the plated material is relatively soft or susceptible to humidity, e.g., copper or zinc, a relatively wearable or inert layer, e.g., nickel or chrome, may be subsequently deposited. The deposition of the second layer may be carried out by electroplating, electroless plating, physical vapor deposition, chemical vapor deposition or sputtering deposition, over the entire surface of the embossing sheet.

Alternatively, if the height (or thickness) of the three-dimensional pattern is relative small, e.g., less than 1 microns, the plating step may be replaced by physical vapor deposition, chemical vapor deposition or sputtering deposition. The deposition is performed on the entire surface of the embossing sheet. Since the deposit is so thin, the material deposited on top of the photosensitive material may be removed together with the photosensitive material in the stripping step.

In practice, a three-dimensional pattern prepared from the process as described above involving an additive (i.e., electroplating, electroless plating, physical vapor deposition, chemical vapor deposition or sputtering deposition) step would be structurally complementary to a three-dimensional pattern prepared from the process as described above involving a subtractive (i.e., etching) step.

While micro-posts are specifically mentioned, it is understood that the three-dimensional pattern may be of any shapes or sizes. A wide variety of sizes may be achieved for the elements (such as the micro-posts) on the three-dimensional pattern, ranging from sub-microns to much larger.

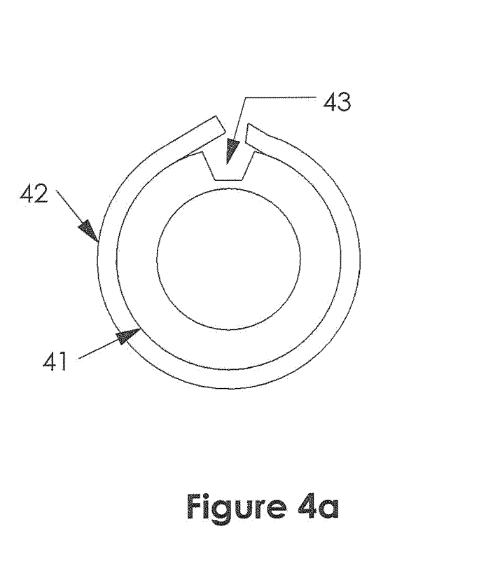

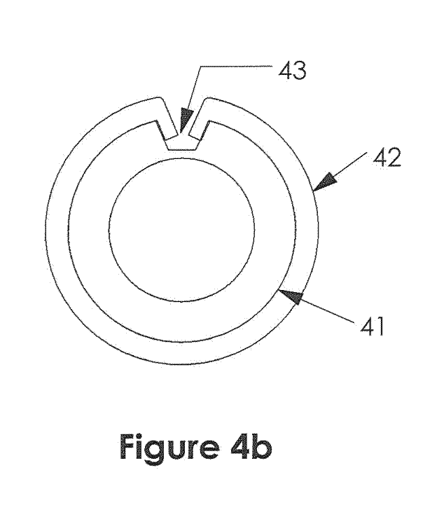

As shown in FIG. 4a, a cross section view shows that an embossing shim (42) with a three-dimensional pattern (not shown) on its outer surface is wrapped around the insert (41) to become an embossing sleeve. The two ends of the shim are folded into the groove (43), along the length of the groove.

FIG. 4b is an enlarged cross section view of the groove (43). After the two ends are folded into the groove, a filler material is filled into the groove. The filler material may be a solder material such as a tin-containing solder material which may be applied by hot soldering process. Alternatively, the filler material may be a curable material which may be applied by squeezing into the groove followed by UV or thermal curing. The cured material is preferred to have strong adhesion (bonding) to the shim, but no adhesion to the embossing composition for forming the microstructure. A thin layer of Teflon or silicon-containing material can be applied to the surface of the cured filler material to provide easy release between the filler material and the embossed composition.

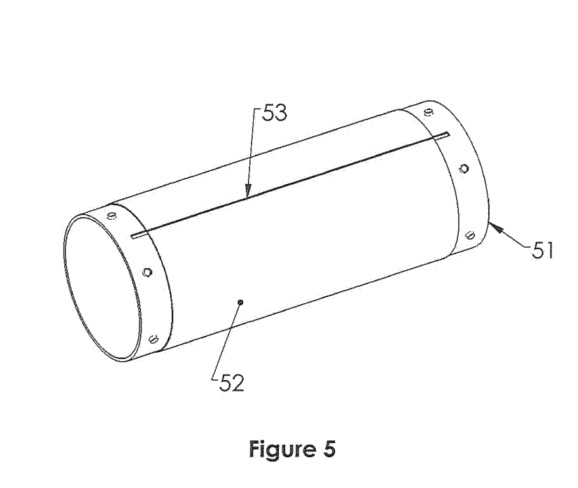

In the final assembly, the length of embossing sleeve (52) in longitudinal (L) direction is preferably narrower than the insert (51) so that the sleeve will not cover the areas on the insert where the screws are present, as shown in FIG. 5. The seam line (53) on the embossing sleeve is where the ends of the embossing shim are folded into the groove on the insert.

In a further embodiment, the assembly does not have the non-expandable insert. The groove as described, instead, appears directly on the drum. In this case, embossing shim is wrapped directly on drum.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

What is claimed is:

1. An embossing assembly comprising:
a) a drum;
b) a non-expandable insert mounted over the drum, wherein the insert comprises a groove on its longitudinal direction; and
c) an embossing sleeve formed from an embossing shim, wherein the embossing shim with a three-dimensional pattern on its outer surface is mounted over the insert and the two ends of the embossing shim are folded into the groove on the insert and secured in the groove by a filler material.

2. The embossing assembly of claim 1, wherein said three-dimensional pattern has micro-posts.

3. The embossing assembly of claim 1, wherein the cross-section of the groove has two sides with an angle, from its vertical axis, of about 0° to about 85°.

4. The embossing assembly of claim 1, wherein the cross-section of the groove has a bottom width of 100 μm to 50 mm.

5. The embossing assembly of claim 1, wherein the cross-section of the groove has an opening width of 101 μm to 51 mm.

6. The embossing assembly of claim 1, wherein said non-expandable insert has multiple tightening means.

7. The embossing assembly of claim 6, wherein the tightening means is screws.

8. A method for the manufacture of an embossing assembly, comprising:
a) providing a drum;
b) providing a non-expandable insert which has a groove on its outer surface in the longitudinal direction and tightening means;
c) providing an embossing shim with a three-dimensional pattern on one side of the shim;
d) wrapping the embossing shim over the non-expandable insert to form an embossing sleeve, with the three-dimensional pattern on the outer surface;
e) folding two ends of the embossing shim into the groove;
f) adding a filler material into the groove to secure the two ends of the embossing shim in the groove; and
g) optionally grinding and polishing the filler material.

9. The method of claim 8, wherein the non-expandable insert is mounted on the drum before the embossing shim is wrapped over the non-expandable insert.

10. The method of claim 8, wherein the non-expandable insert is mounted on the drum after the embossing shim is wrapped over the non-expandable insert.

11. The method of claim 8, wherein said three-dimensional pattern has micro-posts.

12. The method of claim 8, wherein the cross-section of the groove has two sides with an angle, from its vertical axis, of about 0° to about 85°.

13. The method of claim 8, wherein the cross-section of the groove has a bottom width of 100 μm to 50 mm.

14. The method of claim 8, wherein the cross-section of the groove has an opening width of 101 μm to 51 mm.

15. The method of claim 8, wherein said non-expandable insert has multiple tightening means.

16. The method of claim 13, wherein the tightening means is screws.

17. An embossing assembly comprising:
a) a drum comprising a groove on its longitudinal direction; and
b) an embossing sleeve formed from an embossing shim, wherein the embossing shim with a three-dimensional pattern on its outer surface is mounted over the drum and the two ends of the embossing shim are folded into the groove on the drum and secured in the groove by a filler material.
